(19) United States
(12) Patent Application Publication
(10) Pub. No.: US 2011/0055922 A1
(43) Pub. Date: Mar. 3, 2011

(54) Method for Detecting and Blocking Phishing Attacks

(75) Inventors: Ram Cohen, Tel Aviv (IL); Aryeh Mergi, Bazra (IL)

(73) Assignee: ActivePath Ltd., Petah Tikva (IL)

(21) Appl. No.: 12/872,149

(22) Filed: Aug. 31, 2010

(30) Foreign Application Priority Data
Sep. 1, 2009 (GB) UK 0915157.2

(51) Int. Cl. G06F 21/00

(52) U.S. Cl. 726/22

(57) ABSTRACT

A method for detecting a suspected phishing attack characterized by monitoring strings of characters in a questionnaire presented by a non-approved address to a user terminal for similarity to a substring of a string of sensitive data, such that the substring has a length of one or more characters less than the length of the string of sensitive data, such that on detecting a substring of critical length, an alert is triggered.

### PRIORITY INFORMATION

The present invention claims priority, under the Paris Convention, to United Kingdom Patent Application No. UK0915157.2 filed Sep. 01, 2009, making reference to same herein in its entirety.

### FIELD OF INVENTION

The present invention relates to the field of internet security. More particularly, the invention relates to a method and system for detecting and blocking phishing attacks.

### BACKGROUND OF THE INVENTION

Internet banking and commerce depends upon the secure communication of information over the web. In order to carry out a transaction securely, a user generally needs to submit personal information, known hereinafter as credentials, to a remote website. Certain credentials, such as usernames, passwords or the like, may be used in order to identify the user. Other credentials, such as credit card numbers, account numbers or the like, provide details of the means for effecting an internet transaction.

In order to prevent internet fraud, credentials should be kept private. Hackers may attempt to obtain credentials by a technique known as phishing, as described below. The blocking of phishing scams is thus an important element of internet security.

To effect a transaction, credentials may be submitted to an internet location via a web form or the like. Web forms are downloaded from a website by a communication device, such as a computer, mobile phone or the like, connected to the internet. PRIOR ART FIG. 1A schematically shows how a simple web form of the art may be accessed using a computer 10 running a web browser.

The screen 11 of the computer 10 displays the user interface (UI) of the web browser 12, and typically includes an address bar 14 and a viewing pane 16. The browser is configured to download a file 22 from a web location 32, identified by a URL (Uniform Resource Locator), which is entered into the address bar 14. The web location 32 of the example is associated with a banks website 30 and is located by the URL 15: ‘http://www.thebank.co.uk/login.asp’. This URL 15 is referred to herein as the Source-URL. The browser downloads the file 22 from the Source-URL 15 and uses it to construct a web page, including the web form, for displaying in the viewing pane 16.

More complex web pages may be constructed from several files, each with its own web location and unique Source-URL which may or may not be part of the same domain. In such a case the Source-URL of the form may be different from the URL that is displayed in the address bar 14.

In FIG. 1, a simple example of a web page including a form 13 is displayed in the browser's viewing pane 16. The web page is constructed from the file 22 downloaded from the web location 32. The file 22 of the example includes the following HTML code:

<html>

<body>

<H1>Welcome to thebank.co.uk<H1>

<Form action=“http://www.thebank.co.uk/loginprocess.asp” method=“post”>

Username: <input type=“text” name=“user” size=“20”><br>

Password: <input type=“password” name=“password” size=“20”><br>

<input type=“submit” value=“Submit”>

</Form>

</body>

</html>

The resulting visual display, presented in the browser's viewing pane 16, includes: a heading 17 and a form consisting of two input fields 18A and 18B and a ‘SUBMIT’ button 19.

When a user clicks on the ‘SUBMIT’ button 19, the text entered into the input fields 18A, 18B, is submitted to a second web location 34, which is located by a second URL. This second URL is referred to herein as the Destination-URL.

The action taken by the form 13 is defined by the following line of code: <Form action=“http://www.thebank.co.uk/loginprocess.asp” method=“post”>, which defines a URL to which submitted data 24 is posted when the submit button 19 is selected. This third URL is referred to herein as the Stated-URL. In the simple example above, the Stated-URL, given in the code, is the same as the Destination-URL, to which the data 24 are submitted. In more complicated web forms this is not necessarily the case. The Stated-URL may send the data to another section of script within the code, for example, for data validation prior to submitting the credentials to the web location 34 associated with the Destination-URL.

One type of phishing scam attempts to fraudulently acquire credentials from users by mimicking trustworthy websites and luring unsuspecting users into submitting their private credentials to an internet location associated with a phishing site. FIG. 1B shows how a phishing site 30P may mimic the bank website 30 shown in FIG. 1A. The phishing site 30P has a domain name deceptively similar to that of the bank. For example the phishing site 30P of the example has the domain name ‘www.thebank.com’ which is easily confused with the bank's domain name, ‘www.thebank.co.uk’. When a user incorrectly enters the Source-URL, ‘http://www.thebank.com/login.asp’ 15P, into the address bar, the browser downloads the phishing source file 22P from the phishing site's web location 32P.

Phishing scams use a variety of tricks to encourage users to download phishing source files 22P from the phishing site's Source-URL 15P rather than from the genuine URL 15 (FIG. 1). For example, in a typical scam, an email, purporting to be from the bank, is sent to users requesting that they log into their accounts. A link is provided within the email which directs the user to the phishing site's Source-URL 15P. Alternatively, links may be distributed by instant messaging on telephone networks via SMS (Short Message Service) or the like.

Chat sessions are another channel used for phishing scams. For example, a phisher may pretend to be the representative of a service provider in order to tempt a correspondent to visit the phishing site or to provide credentials such as name, social security number and so on.

Another method for stealing sensitive information is to include hidden fields with typical names such as ‘credit card’ in an otherwise ‘innocent’ looking form or questionnaire that only request typical information such as the user name and mail address. Since most browsers (and some add-on tools) provide functionality to automatically fill web forms with frequently used data (such as name, address, credit card information etc.) those tools may automatically complete the hidden fields with the sensitive information without the user knowledge or consent. The contents of such hidden fields will be sent in the submitted form to the phishing site.

The visual display constructed in the browser's viewing pane 16 using the phishing file 22P is generally similar to and may be visually identical to that constructed using the genuine file 22 (FIG. 1) from the bank. Although a different Source-URL 15P generally appears in the address bar 14, most users do not notice this. The unsuspecting user is therefore likely to enter credentials into the form and to submit them, believing that they are being submitted to bank's website 30. However the credentials are actually sent by the form in the phishing file 22P, to the Destination-URL, ‘http://www.thebank.com/loginprocess.asp’, which is different from the Destination-URL of the bank's file 22. In this manner, the credentials are submitted to a web location 34P associated with the phishing site 30P.

Known systems for protecting users from phishing attacks typically compare the Source-URL being accessed by a browser with a blacklist of suspect phishing sites. When a user tries to access a URL associated with a site which is included in the blacklist, the site may be blocked or a warning may be displayed to the user, for example.

Such blacklists are maintained in databases, which may be stored locally on the computer or remotely at some internet location, accessed automatically by the computer and updated regularly. Nevertheless, it will be appreciated that blacklist systems are not fail-safe. New phishing scams are continually being introduced which operate from new phishing sites. There is an inevitable time lag between the introduction of a new phishing site and it being blacklisted and users may falsely submit credentials during this delay period.

There have been a number of developments in anti-phishing software and one publication showing the current state of the art. For example, Ca 2587867 to Electroguard titled “Network Security Device” describes a network security device which acts as an “airlock” for traffic between a communications device and a network. Data is screened using rules based analysis by the security device to counter various threats, including viruses, phishing, attempts to “hijack” communications, communications with known malicious addresses or unknown addresses, and transmission of sensitive information. Data packets can be reassembled into files for screening, and decoded or expanded as necessary, but is never executed. The data path for the data being screened is kept separate from the operations of the network security device itself, so that the device is incorruptible—its programming cannot be compromised from outside sources. Updates for rules and entry of sensitive data for screening, etc., must be done through a physical interface, not via the normal data communications channel. The device is invisible—it cannot be “seen” by the network, and thus cannot be attacked.

WO 2008/146292 to Klikli titled “System and Method for Security of Sensitive Information Through a Network Connection” describes a system and method for preventing phishing attacks by comparing the address of a Web site to which a user wishes to enter sensitive information (or indeed any type of user information) to at least one previous address to which the user already submitted at least a portion of this information. If the current address and the previous address are not identical, the user is preferably at least alerted; more preferably transmission of the information is blocked. The present invention may also optionally operate even if only a portion of the sensitive information is submitted, such as only the password for example.

What is common to all such methods is that a web-form or the like is filled out with sensitive data, and subsequently, usually when a distinct submission action is performed, a mediator of some sort, typically a software application on the internet enabled user terminal, or accessible by the Internet, looks up sensitive credentials and web addresses in a table or database and stops submission if something suspicious is detected, or if the website has not been authorized.

The submit event is typically the pressing of an ENTER key, or clicking on a SUBMIT 10 or SEND button, although in WO 2008/146292 to Klikli, an additional submission is contemplated, where a time delay is detected and used to trigger the data submission.

It has been determined that in one phishing scam a bogus form can be displayed to a user and, using JavaScript code, the provided password can be transmitted to a remote location as it is being typed in, character by character, without the user ‘submitting’ the data. In fact, the bogus form may be configured to submit the data to the intended location so as to minimize the likelihood of the destination being alerted.

In such a scenario a form may be downloaded to the end user from a bogus URL, but the data is submitted to a different domain, i.e. the real URL of the destination, say a bank, in real time.

In one risk scenario, a malicious proxy injects JavaScript code into a web page to steal the password as it is being typed. In such a case, the URL looks valid but the password is, nevertheless, stolen. Thus it is possible that code in the page will steal the data before the user knowingly submits the form. Such stealing can even take place on a character by character basis.

In another high risk scenario, the entry of sensitive data is concealed by a plurality of adjacent fields being used instead of a single field. Thus, for example, a 16 digit credit card number can be submitted in four 4-digit fields or perhaps eight two digit fields. Prior art and -phishing methods and systems will be unaware that a credit card number was submitted, since it was submitted in fragments, and the prior an anti phishing methods and systems look at each field separately. Thus a phishing form which accepts sensitive data in a plurality of form fields will generally overcome the prior an protection methods.

Where the user has configured a prior art system that generally detects sensitive data such as passwords or credit card details, he may be lulled into a false sense of security by being able to type in a password or credit card number into multiple fields. Thus what should be a protection method is, in this regard, a security risk.

Since phishing scams may be very profitable, there is ongoing development thereof, and there is an ongoing need for additional/improved systems for protecting users from phishing scams.

Intrinsic to prior art solutions is the fact that only subsequent to an attempt to transmit previously used passwords, bank account details or pin numbers to a web address, is the mediator activated. If the website address is known from a white-list, or is blacklisted or appears suspicious for some reason, the mediator performs blocking actions, allows data to be transmitted or issues alerts accordingly. There are, however, a number of sophisticated phishing schemes that monitor keystrokes of passwords and account details as they are typed, and prior to the submission process, have already stolen the sensitive data.

Embodiments of the present invention address these and similar issues.

### SUMMARY OF THE INVENTION

In a first aspect, the present invention is directed to providing a method for detecting a suspected phishing attack characterized by monitoring strings of characters input to a questionnaire presented by a non-approved address to a user terminal, for similarity to a substring of a string of sensitive data, such that said substring has at least a predefined critical length of at least one character less than the length of the string of sensitive data, such that on detecting a substring of critical length, an alert is triggered.

Preferably the substring is at least two characters less than the length of the critical string, but could be 3 or 4 characters less.

The substring may also have a predetermined minimum length of 2, 3, 4 or more characters. Optionally, the substring is between 10% and 90% of the string of sensitive data. More preferably the substring comprises between 70% and 80% of the string of sensitive data.

Optionally, the monitoring is triggered by a mouse click.

Additionally or alternatively, the monitoring is triggered by data entry.

Additionally or alternatively, the questionnaire comprises a plurality of fields and the stage of monitoring is triggered by inputting data in a new field.

Optionally the substrings of characters in the questionnaire are pre-inserted field values and the alert is triggered by a change in the pre-inserted field values.

Optionally, the questionnaire includes a plurality of fields and the critical length of a substring overlaps a plurality of fields in the questionnaire.

Optionally, the user terminal is selected from the group consisting of computers, mobile phones and personal organizers.

Alternatively, the user terminal is internet-enabled and the node of the data network is an address on the Internet.

Alternatively, the user terminal transmits data over a telephony or data link selected from the group consisting of cable telephony networks, cellular telephony networks fiber-optic cable, wired telephone, cellular phone, wifi links, Bluetooth connections, WiMax connections, radio connections and satellite connections.

Typically the non-approved address fulfils at least one of the following criteria:
1. Appears on a blacklist of phishing addresses
2. Does not appear on a white list of authorized addresses
3. Is not an address that was previously visited by user and approved

Typically the web address is selected from the group consisting of IP address, URL and domain name.

Optionally, the questionnaire is a web-form.

Typically, the questionnaire comprises a request for sensitive data.

Typically, the sensitive data string comprises at least one of password, username, credit card details, pin number and social security number.

Optionally the sensitive data string is identified as such by a field label such as password or credit card number.

Optionally the sensitive data string is identified as such by a field attribute.

Optionally the sensitive data string is identified as such by a comment in the questionnaire.

Optionally the sensitive data string is identified as such by an intrinsic characteristic of the data string.

In one embodiment, the sensitive data string comprises a credit card number and an intrinsic characteristic of the data substring is a sequence of numbers starting with first few digits of a credit card number.

Optionally the sensitive data string comprises a password and the intrinsic characteristic of the data substring is a sequence including both numbers and letters.

Optionally the sensitive data string comprises a password and the intrinsic characteristic of the data string is a sequence including both upper and lower case characters, with at least one upper case characters following initial letter.

Optionally the sensitive data string comprises a password and the intrinsic characteristic of the data string is a sequence including at least one character on a qwerty keyboard that is not a number or letter.

Optionally the sensitive data string comprises a password and the intrinsic characteristic of the data string is a sequence including at least one character on a qwerty keyboard that is not a number or letter.

Optionally the sensitive data string is identifiable by a same string requiring being retyped in subsequent fields of the table.

Optionally the sensitive data string is identifiable by being displayed in a disguised form.

Optionally the method is implemented by a computer program stored in a memory.

Optionally the memory is a removable storage memory.

Optionally, the memory is a flash memory accessible via a USB port.

In one embodiment, the method comprises a previous step of examining web address on presenting user with a questionnaire, prior to a subsequent step of inputting data in response to the questionnaire.

Optionally, the alert is sent to a third party, such as an internet security service provider, for example.

By sensitive data, specific strings such as passwords, bank account details and social security numbers are intended.

By address, the IP address, URL or domain name is intended.

The term manual entry of data relates to typing in data via key-presses or by pasting the data.

The term automatic data entry relates to recognition of a field by its name, and/or by characteristics of the data used.

The term alert as used herein is used somewhat loosely. In addition to including optionally actively alerting the user by sounding an audible alarm or displaying a visual message, the alert could be sent to a third party and could include alerting the user's system to take action by blocking data-entry in a manner that may be transparent to the user.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

PRIOR ART FIG. 1A schematically shows how a simple web form of the art is accessed by a computer running a web browser;

PRIOR ART FIG. 1B schematically shows how a phishing site as known, may mimic the website shown in FIG. 1A in order to fraudulently obtain credentials from an unsuspecting user;

FIG. 2 is a flowchart representing a generalized method for preventing credentials from being submitted to an unauthorized web location, according to an embodiment of the invention.

### DESCRIPTION OF PREFERRED EMBODIMENTS

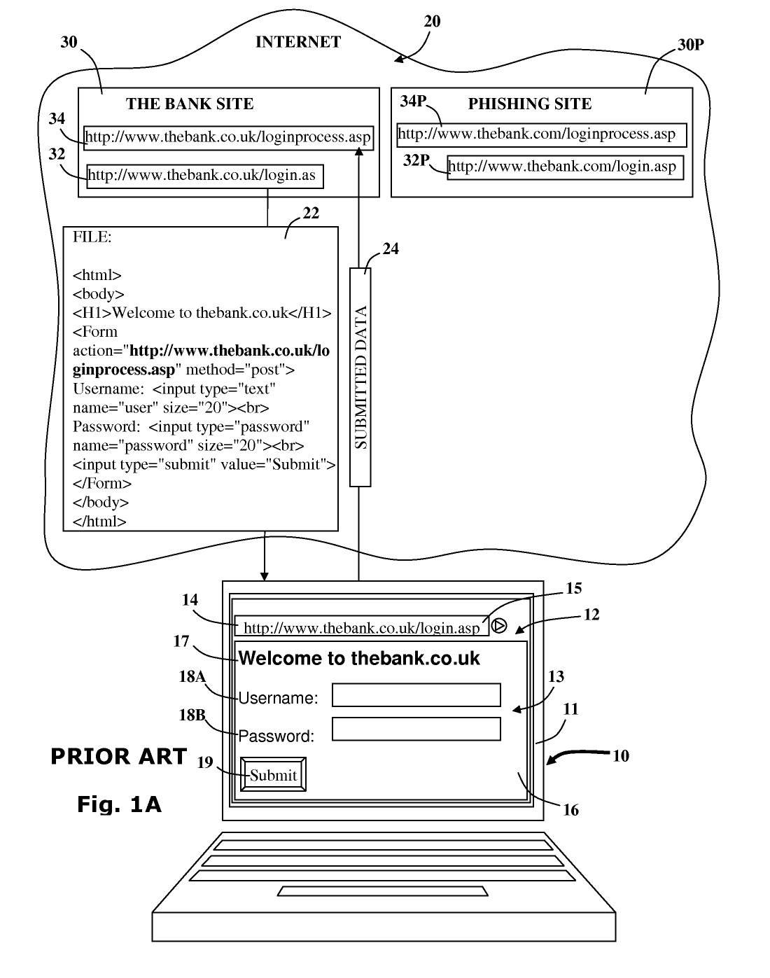

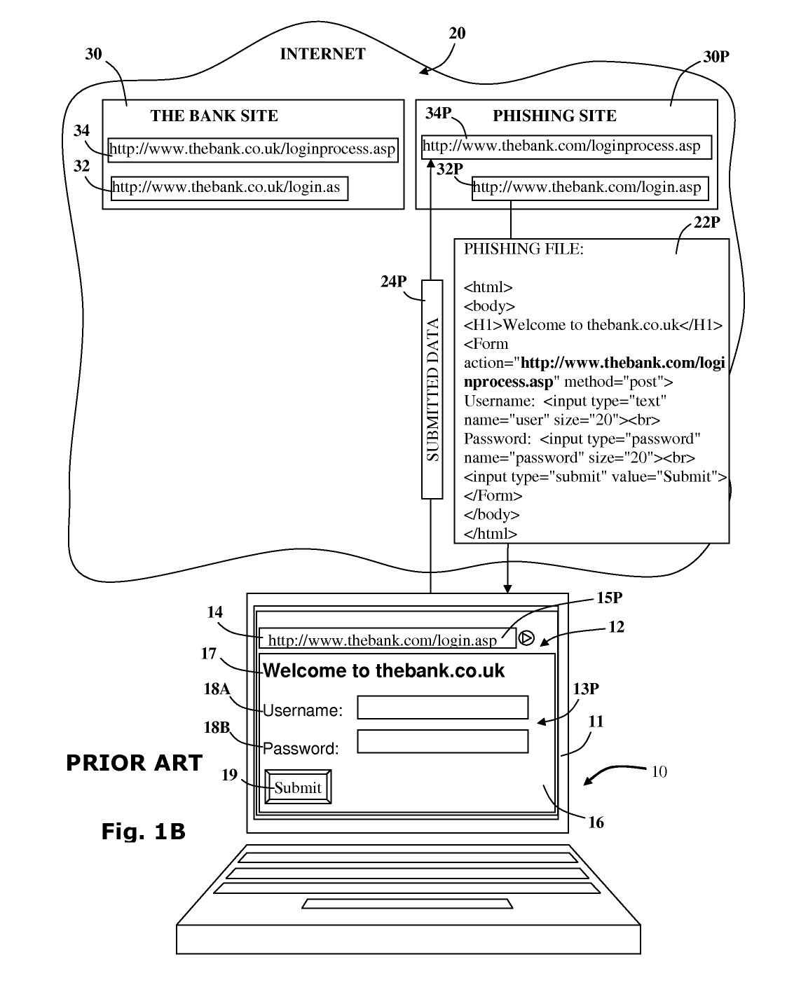

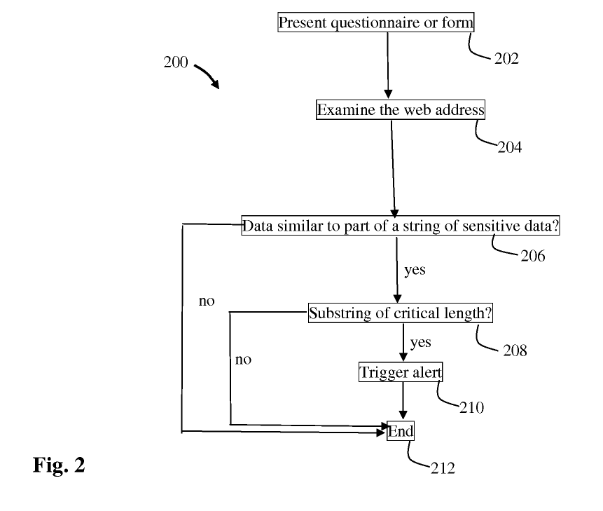

With reference to FIG. 2, in accordance with one embodiment of the invention, the present invention is directed to an anti-phishing method 200 and system that monitors websites as the user surfs the net and warns of phishing susceptibility prior to entering sufficient data to compromise the user.

The method 200 consists of whenever the user is presented 202 with a form, the web address (e.g. URL, IP address, etc.) is examined 204. If the data is similar to part of a string of sensitive data 206 and has a critical length 208 which may be absolute or relative to the string of sensitive data, then an alert 210 is triggered. Otherwise, no alert is triggered and the testing routine is ended 212.

Preferred embodiments of the anti-phishing method 200 include a number of unique features:

Typically sensitive data such as PIN numbers, credit card numbers and passwords are identified as such by at least one of the following means:
a. preconfiguration, where in a set-up procedure, sensitive data is supplied to a database where it is stored, possibly in an encoded format.
b. previous usage in a field labeled password or credit card number
c. typical characteristics, such as combination of numbers and letters, upper case characters in the middle of strings or non-alphanumeric symbols such as #$%*̂&*, etc. in the middle of strings
d. Any field that is configured to display asterixes, dashes, black dots or the like, will be identified as sensitive
e. The type of field as defined in the form (ex. ‘Input type=“password” in an HTML form)
f. The string displayed in the form prior to the entry field (such as ‘User name:’ before the entry field)
g. The sensitive data string is identified as such by a field attribute
h. The sensitive data string is identified as such by a comment in the questionnaire

Alternatively, the system could be dynamically configured so content embedded in an HTML page or downloaded from a remote location could be used to provide information to be stored in the database. Appropriate information includes user id, passwords and the like. The sensitive data (in clear form, hash form etc.) and other values that can be stored in the database is stored in relation to the URL of the HTML page.

The method 200 over-rides the automatic data entry, so such data strings cannot be supplied automatically under any circumstances. Furthermore, such data strings are not eligible for automatic completion, so that typing the first character cannot result in the string being offered to the user in a drop-down box or automatically completed.

In addition to monitoring input of substrings of characters, preferred embodiments of the invention monitor pre-inserted field values in the questionnaire and an alert is triggered by a change in the pre-inserted field values. This may be achieved by comparing the values with field identifiers as stored in a database, either on the user system or accessible thereto.

It will be noted that in preferred embodiments, an alert is triggered even in cases where the substring of a critical length overlaps a plurality of fields, so as to provide protection against cunningly designed phishing forms, where, for example, if a critical length of a credit card number is set to five or six digits, and a 16 digit credit card is input into four four-digit fields, even though the substring of critical length is input into two separate fields of the questionnaire, nevertheless, an alert will be triggered.

Preferably, the database which stores the sensitive data stores it in hashed and/or encrypted form so that breaking into the database will not enable retrieval of the sensitive information. Manual entry of such strings results in a preventative measure occurring. The preventative measure typically includes displaying a warning that this is a site that has not been visited before with new address. If there are features that are known such as similar domain to trusted address but different in some critical aspect such as a different suffix; .gov instead of .com, or .eu instead of .uk, may include a highlighted warning that could be in red, flashing etc. and could optionally include disabling the user interface to prevent further keys being pressed until user actively over-rides the safety feature. Similarly, a variant prefix with a non-identical address having a high degree of similarity, such as, inter alia, doubling of consonant in the middle of word; using a 1 (one) instead of an 1 (el letter) (which in many fonts look the same), or an O (oh letter) instead of a zero, will trigger an alert which preferably includes a detailed warning that highlights the similarity and/or the differences to allow the user to make an informed decision as to whether to proceed or not.

It will be appreciated that some address differences such as a variant IP address is “low risk” in that generally, such changes are indicative of mirror sites for load bearing and the like. Optionally, where there is a high likelihood of the address being indicative of a phishing scam, (e.g. an el instead of a one) the system and method disable the keyboard or provide a pop up warning window requiring closing via a mouse click or similar, thereby preventing further keystrokes until user actively authorizes continuing.

Regarding passwords and usernames, it will be appreciated that many users have trouble remembering large numbers of passwords and often use something inadequately short and often meaningful rather than random. The password is often a combination of a nickname or the spouse or mother's name and the last few digits of phone number. Such passwords are easily cracked by brute force, and if the first few digits are known, the last few can be broken quite easily. In preferred embodiments of the invention, the system adds a suffix to a password and encodes prior to transmission. The user is unaware of this and types in a string of say, 7 or 8 letters and numbers (too often user_name1234 or the like), but the system adds some random suffix, e.g. W4%@ and then the combination user_name1234W4%@ may be hashed or otherwise transformed or encoded. In this manner, the transmitted password is rather more secure than that remembered by the user. A downside of this system is that the user must be using a terminal that is enabled with the system and method. In one embodiment, the method is encoded on a flash memory accessible by a USB port (and the system includes the memory), so the user may use any computer terminal if he takes the precaution of loading an embodiment of the invention via a USB port.

Other implementations include browsing via a remote terminal connection and via a web-based interface that is accessible via a separate password.

In essence, therefore, embodiments of the present invention are directed to recognizing substrings of sensitive data prior to a whole string being submitted, either via a single field or split across a number of fields, which is a phishing susceptibility that prior art systems seem to have missed. The string may be recognized by intrinsic characteristics of passwords, credit card numbers, social security numbers, field labels, such as “Password:” etc. as described above. In one embodiment designed to catch streaming of characters as typed or submissions in sub fields of say 2, 3 or 4 characters, the present invention reads inputted data as a continuous string and looks for sequences. Generally in this manner, as soon as the first few characters of a longer string are input, the system is alerted. It will be appreciated that there is always a trade-off between sensitivity and false positives. Sending an alert re typing a password with only the first couple of letters typed is clearly liable to create many false alarms, particularly where, as unfortunately is all too often the case, the password starts off as a nickname or the like, and is related to the real name. It will be appreciated that any two digit number has a 0.01 chance of matching the first two digits of a credit card or other number. If, however, the first say, 14 out a 16 digit credit card number is transferred, before a system shuts down, then by brute force, there are only a hundred options to try. The appropriate string length to minimize false alarms but to provide a high level of safety against phishing will vary with application, with string length and the like. Typically, for safety, the appropriate string length will be a least 3 characters, with 4, 5 or 6 characters being better, of course. An alert should be triggered where at least one character has not yet been entered, and, better, where two, three or four or more characters have not yet been entered. If the string is a number, and each not-transferred character is a digit, it will be appreciated that a longer safety factor is required than for passwords, where the final digits may be numbers or letters or other characters, and may be upper or lower case. Typically the sensitivity should be set to trigger an alert if somewhere between 20% and 80% of the string is transmitted. More typically, the system and method is configured to trigger an alert if between 30% and 70% of the string is inputted, and most typically if between about 40% and about 60% of the string is inputted.

Detection of the substring sent to a non-authorized website, whether blacklisted or simply not explicitly white-listed, may close application completely. Generally however, a warning will pop-up that will suspend the application until the user instructs how to proceed with the data entry or submission.

Where a suspected phishing site is detected, usefully a warning is sent to a central database common to a plurality of users and/or to an Internet policing site and/or to hosting organizations, search engines and the like.

The scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A method for detecting a suspected phishing attack characterized by monitoring strings of characters in a questionnaire presented by a non-approved address to a user terminal for similarity to a substring of a string of sensitive data, such that said substring has a length of one or more characters less than the length of the string of sensitive data, such that on detecting a substring of critical length, an alert is triggered.

2. The method of claim 1 wherein the substring is characterized by being either
(i) at least one two characters shorter than the string of sensitive data;
(ii) between 10% and 90% of the string of sensitive data.

3. The method of claim 1, wherein the monitoring is triggered by an event.

4. The method of claim 3, wherein the event is selected from the group comprising a mouse- click, a key-press and data entry.

5. The method of claim 1, wherein the monitoring is done periodically.

6. The method of claim 1, wherein said questionnaire comprises a plurality of fields and said stage of monitoring is triggered by inputting data in a new field.

7. The method of claim 1 wherein the substrings of characters in the questionnaire are pre-inserted field values and the alert is triggered by a change in the pre-inserted field values.

8. The method of claim 1 wherein the questionnaire includes a plurality of fields and the critical length of a substring overlaps a plurality of fields in the questionnaire.

9. The method of claim 1 further comprising a limitation selected from the group of:
(a) wherein the user terminal is selected from the group consisting of computers, mobile phones and personal organizers;
(b) wherein the user terminal is internet-enabled and the node of the data network is an address on the Internet, and
(c) wherein the user terminal transmits data over a telephony or data link selected from the group consisting of cable telephony networks, cellular telephony networks fiber-optic cable, wired telephone, cellular phone, wifi links, Bluetooth connections, WiMax connections, radio connections and satellite connections;

10. The method of claim 1 wherein the non-approved address fulfils at least one of the following criteria:
a. Appears on a blacklist of phishing addresses;
b. Does not appear on a white list of authorized addresses;
c. Is not an address that was previously visited by the user and authorized.

11. The method of claim 1 wherein the web address is selected from the group comprising an IP address, a URL and a domain name.

12. The method of claim 1 wherein at least one of the following is true:
(a) the questionnaire is a web-form, andl
(b) the questionnaire comprises a request for sensitive data.

13. The method of claim 1 wherein the sensitive data string comprises at least one of the group comprising a password, a username, credit card details, a pin number, a passport number, an account name and a social security number.

14. The method of claim 1 wherein the sensitive data string is identified as such by an attribute of the field into which it is entered and/or by a field label.

15. The method of claim 1 comprising a previous step of examining a web address on presenting user with a questionnaire, prior to a subsequent step of inputting data in response to the questionnaire.

16. The method of claim 15 wherein the field label is selected from the list comprising a password, a pin number, a social security number and a credit card number.

17. The method of claim 1 wherein the sensitive data substring is identified as such by an intrinsic characteristic of the data string.

18. The method of claim 17 wherein:
(i) the sensitive data substring comprises a sequence of numbers starting with first few digits of a credit card number; (ii) a substring of a password and the intrinsic characteristic of the data substring is a sequence including both numbers and letters;
(iii) the sensitive data substring comprises a section of a password and an intrinsic characteristic of the data string is a sequence including both upper and lower case characters, with upper case characters after a first letter of the substring;
(iv) the sensitive data substring comprises a section of a password and the intrinsic characteristic of the data substring is a sequence including at least one character on a qwerty keyboard that is not a number of letter;
(v) the sensitive data substring comprises a section of a password and an intrinsic characteristic of the data string is a sequence including at least one character on a qwerty keyboard that is not a number of letter;
(vi) the sensitive data substring is identifiable by a same sub string being retyped;
(vii) the sensitive data string is identifiable by being displayed in a disguised form as it is typed on the user terminal;
(viii) the method is implemented by a computer program stored in a memory;
(ix) the memory is stored in a removable storage memory, and
(x) the memory is stored in a flash memory accessible via a USB port.

19. The method of claim 1 wherein said alert is sent to a third party.

20. The method of claim 19 wherein said third party is an internet security service provider.
